(19) United States
(12) Patent Application Publication
(10) Pub. No.: US 2007/0039257 A1
(43) Pub. Date: Feb. 22, 2007

(54) Low profile architectural detailing assembly

(76) Inventors: Dorian M. LeBlanc, Mission (CA); Richard M. Patterson, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/198,653

(22) Filed: Aug. 5, 2005

(51) Int. Cl. E06B 1/04

(52) U.S. Cl. 52/211

(57) ABSTRACT

An architectural detailing assembly adapted to be attached to a building structure. The architectural detailing assembly includes a base member and a finish member. The base member is adapted to be attached to the building structure. The base member includes a first interface structure. The finish member is adapted to be attached to the base member. The finish member includes a second interface structure adapted to cooperatively interface with the first interface structure to aid in supporting the finish member upon the base member.

### FIELD OF THE INVENTION

The illustrated embodiments of the present invention relate generally to architectural detailing assemblies and, more particularly, to architectural detailing assemblies which are able to be easily installed to a structure.

### BACKGROUND OF THE INVENTION

An architectural detail can transform a standard doorway into a grand archway and a fireplace mantle into a room's centerpiece. Finishing touches such as moldings and cornices are widely used in the building industry as a way to increase the aesthetic and economic value of a building. To obtain market share and to establish a reputation, builders are seeking out variations on classic architectural detailings.

In the recent past, architectural detailings were typically formed from stone/concrete or wood. With a number of advancements made within the foam industry, many builders are now utilizing pre-coated foam architectural detailings. One reason for their popularity is that they have a similar look and feel to precast, natural stone products, or wood, at the same time providing a significant reduction in raw material and installation costs. The foam based architectural detailings are also being used to accommodate climates adverse to wood and to offset rising wood costs

In a typical construction, a mesh is applied to a foam core, then it is coated and topped with a stone like or other finish to create a product that is strong and aesthetically pleasing. The resulting product may be one-tenth the weight of precast stone. Further, the resultant product is easier and costs less money to install. It can be made in any shape and size. The manufacturing time is considerably less as well, and the cost is around 40 percent less for the installation of a foam product versus a precast product.

The foam base is easily formed into any shape, allowing designers wide latitude in designing the shape of the architectural detailings. The design aspects for coated foam products are infinite and have become extremely popular with architects and interior designers alike. The foam is dimensionally stable, resistant to expansion, contraction, warping, rotting and twisting. Additionally the foam is not a nutrient source for insects, which is important in humid and termite-prone climates.

Although previously developed faux architectural detailings are effective, they are not without their problems. It has been discovered that previously developed faux architectural detailings are not well adapted for installation when the thickness of the architectural detailing exceeds a selected thickness. Moreover, when the thickness of the architectural detailing exceeds a maximum depth of a cut of a standard rotary saw, installers are not able to easily, accurately, and/or rapidly cut the architectural detailing in the field. Plus, the large size of the architectural detailing makes the architectural detailing awkward to handle, decreasing the ease and quality of installation. Thus, there exists a need for an architectural detailing assembly that is easy to cut and install, that is reliable, and inexpensive to manufacture.

### SUMMARY OF THE INVENTION

One embodiment of an architectural detailing assembly formed in accordance with the present invention and adapted to be attached to a building structure is disclosed. The architectural detailing assembly includes a base member adapted to be attached to the building structure. The base member includes a first interface structure. The architectural detailing assembly also includes a finish member adapted to be attached to the base member. The finish member includes a second interface structure adapted to cooperatively interface with the first interface structure to aid in supporting the finish member upon the base member.

Another embodiment of an architectural detailing assembly formed in accordance with the present invention and adapted to be attached to a building structure is disclosed. The architectural detailing assembly includes a base member formed from extruded cellular material and adapted to be attached to the building structure. The base member has a first interlocking structure. The architectural detailing assembly further includes a finish member formed from extruded cellular material. The finish member includes a second interlocking structure adapted to cooperatively interlock with the first interlocking structure disposed on the base member for interlocking the finish member to the base member. The architectural detailing assembly also includes an anchor fastening member at least partially embedded in the base member, the anchor fastening member adapted to provide a rigid structure for a fastener to attach thereto. The architectural detailing assembly further includes an attachment fastening member at least partially embedded in the base member, the attachment fastening member adapted to provide a rigid structure for coupling the base member to the building structure.

Still another embodiment of an architectural detailing assembly formed in accordance with the present invention and adapted to be attached to a building structure is disclosed. The architectural detailing assembly includes a base member formed from extruded cellular material and adapted to be attached to the building structure. The architectural detailing assembly also includes a finish member formed from extruded cellular material and having interlocking structures for interlocking with cooperatively shaped interlocking structures disposed on the base member for interlocking the finish member to the base member. The architectural detailing assembly still further includes an extruded finish material covering at least a portion of the finish member.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is a perspective view of one embodiment of an architectural detailing assembly formed in accordance with the present invention, the architectural detailing assembly shown attached to a wall of a building to form a cornice;

FIG. 2 is a perspective view of a base member of the architectural detailing assembly being attached to the wall of the building during installation;

FIG. 3 is a perspective view of a finish member of the architectural detailing assembly being attached to the base member of FIG. 2 during installation; and

FIG. 4 is a cross-sectional end view of an alternate embodiment of an architectural detailing assembly formed in accordance with the present invention, the architectural detailing assembly shown attached to a wall of a building to form a cornice.

### DETAILED DESCRIPTION OF THE PREFERRED EMBODIMENT

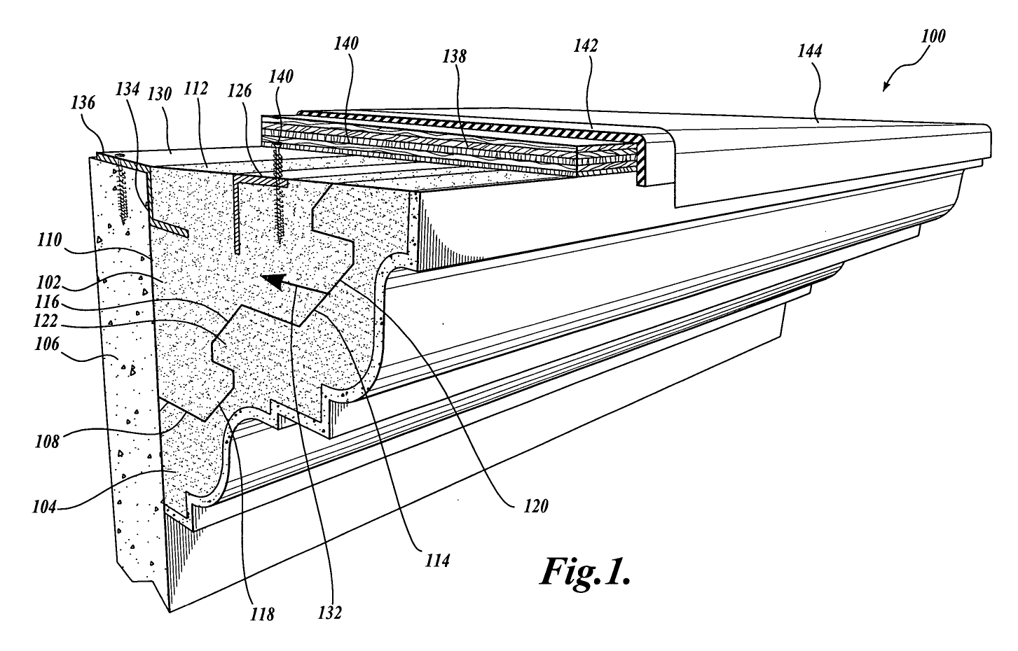

Referring to FIGS. 1-3, one embodiment of an architectural detailing assembly 100 formed in accordance with the present invention is shown. Generally described, the architectural detailing assembly 100 includes a base member 102 and a finish member 104. The base member 102 may be attached to a building structure 106, one suitable example being a weatherproof, code-compliant wall system. The finish member 104 is then coupled to the base member 102 to form the finished architectural detailing assembly 100.

The architectural detailing assembly 100 of the illustrated embodiment is formed from two or more sections (i.e., the base member 102 and the finish member 104 for the illustrated embodiment) which may be interlocked together to form a finished cornice. By forming the cornice from multiple sections, the cornice can be assembled from multiple parts, each part having a reduced depth relative to the overall depth of the cornice. Thus, the cornice can be formed from multiple parts, each having a reduced size, permitting each piece of the cornice to be more easily handled during manufacturing, shipping, storing, displaying, and installation. Further, the reduced depth of the pieces forming the cornice permits each piece of the cornice to be cut with standard tools found in the industry, simplifying and reducing the cost of the installation process, and eliminating the need for custom saws that can handle cutting through the full depth of the architectural detailing assembly.

Referring to FIG. 1 and in light of the above general description of the architectural detailing assembly 100, the components of the architectural detailing assembly 100 will now be described in greater detail. As stated above, the architectural detailing assembly 100 of the illustrated embodiment includes a base member 102 and a finish member 104. Focusing on the base member 102, the base member 102 may be an elongate member formed from a rigid or semirigid material, a few suitable examples being cellular materials, extruded materials, molded materials, foam, etc. In one working embodiment, the base member 102 is made from extruded foam which is extruded through a die having a preselected perimeter shape 108, such as the perimeter shape 108 shown.

The illustrated perimeter shape 108 includes a back surface 110 that may be adapted to abut the outer, vertically oriented, surface of the building structure 106. The illustrated perimeter shape 108 also includes a top surface 112 extending outward from the back surface 110. The top surface 112 may be perpendicularly oriented relative to the back surface 110, or may be inclined at other angles to the back surface 110. For instance, in the illustrated embodiment, the top surface 112 is oriented greater than 90 degrees relative to the back surface 110 such that the top surface 112 is inclined relative to a horizontal plane when installed. This inclining of the top surface 112 relative to a horizontal plane aids in impeding water build up on the top surface 112 by providing a sloped surface for directing rain water off of the top surface 112. In the illustrated embodiment, the top surface 112 is sloped toward the building structure 106, which in the illustrated embodiment, is a parapet. Thus, rain water is directed onto a roof for disposal. For instance, the top surface 110 may be inclined relative to the top surface 112 from greater than about 90 degrees to 135 degrees, and more preferably from greater than about 90 degrees to 105 degrees, even more preferably from about greater than about 90 degrees to 100 degrees, and most preferably about 93 degrees.

An interface surface 114 may extend diagonally between the back and top surfaces 110 and 112. The interface surface 114 is adapted to interlock with the finish member 104. To accomplish the interlocking, the interface surface 114 may include one or more interfacing or interlocking structures adapted to interlock with correspondingly shaped interfacing or interlocking structures disposed on the finish member 104. Moreover, in the illustrated embodiment, the base member 102 includes interlocking structures in the form of alternating recesses, such as grooves 116, and protrusions, such a tongues 118. These interlocking structures 116 and 118 are adapted to interlock with correspondingly shaped interlocking structures associated with the finish member 104, the interlocking structures being recesses, such as grooves 120, and protrusions, such as tongues 122, adapted to interlock with the tongues 118 and grooves 116 of the base member 102, respectively. In the illustrated embodiment, the interlocking structures 116, 118, 120, and 122 are elongate members which are oriented substantially parallel with and extend along substantially the entire length of their respective base or finish member 102 or 104. The interlocking structures 116, 118, 120, and 122, may be oriented to permit the finish member 104 to be slidingly engaged with one another by sliding the finish member 104 towards the base member 102 in a first direction 132. If needed, the finish member 104 may also be slid longitudinally along the length of the base member 102 to align the end face of the finish member 104 to the end face of the base member 102. However, the interlocking structures 116, 118, 120, and 122 interact with one another to impede movement of the finish member 104 perpendicular to the first direction 132, with exception of along the length of the base member 102, as noted above. An adhesive, or other fastening method, such as mechanical fasteners, may be used to secure the finish member 104 to the base member 102.

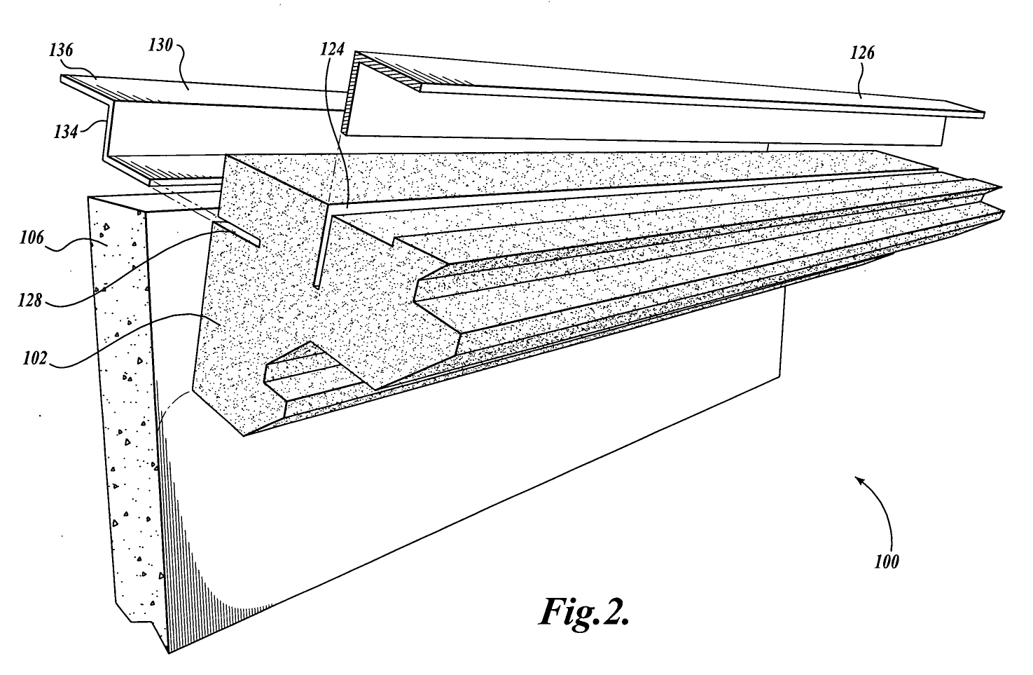

Turning to FIG. 2, the base member 102 may include a preformed anchor recess 124 for receiving an anchor fastening member 126 which may be used, as described in more detail below, to fasten a building material, such as water proofing material, to the architectural detailing assembly 100. For instance, the base member 102 may be extruded so as to include the preformed anchor recess 124 extending along a length of the base member 102. The preformed anchor recess 124 may be shaped and sized to cooperatively receive the anchor fastening member 126. Preferably, the preformed anchor recess 124 is substantially the same shape as the anchor fastening member 126 such that the anchor fastening member 126 is fully received within the base member 102 with a top outer surface of the anchor fastening member 126 being flush mounted in the base member 102. The anchor fastening member 126 may be secured within the preformed anchor recess 124 by any suitable means, a few suitable examples being applying an adhesive to the anchor fastening member 126 prior to insertion of the anchor fastening member into the preformed anchor recess 124, by interference fit, or through the use of fasteners.

The base member 102 may also include a preformed attachment recess 128 for receiving an attachment fastening member 130 which may be used, as described in more detail below, to fasten the architectural detailing assembly 100 to the building structure 106. For instance, the base member 102 may be extruded so as to include the preformed attachment recess 128 extending along a length of the base member 102. The preformed attachment recess 128 may be shaped and sized to cooperatively receive an L-shaped base portion 134 of the attachment fastening member 130 with a tab portion 136 extending outward from the base member 102. The tab portion 136 may then be fastened to the building structure 106.

Preferably, the preformed attachment recess 128 is substantially the same shape as the base portion 134 of the attachment fastening member 130 such that the base portion 134 is fully received within the base member 102. The attachment fastening member 130 may be secured within the preformed attachment recess 128 by any suitable means, a few suitable examples being applying an adhesive to the attachment fastening member 130 prior to insertion of the attachment fastening member 130 into the preformed attachment recess 128, by interference fit, or through the use of fasteners.

The base member 102 is preferably of a reduced depth such that the base member 102 may be easily cut with standard power tools. For instance, in one embodiment, the base member is less than about 5 inches in height and/or width, such that standard power tools can cut the base member 102 in one pass. Preferably, the base member 102 is less than about 4 inches in height and/or width such that a standard circular saw can cut through the base member 102 in one pass, resulting in significant cost and labor savings over conventional applications which require custom saws to cut through the entire width and/or height of the cornice piece in one pass.

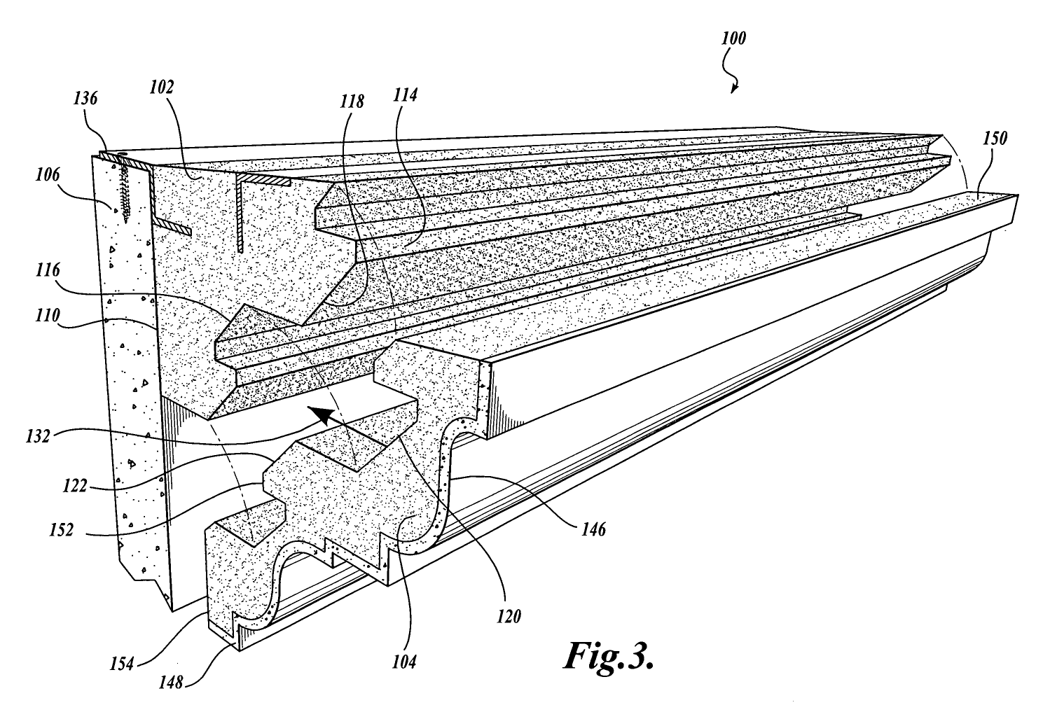

Turning to FIG. 3, the finish member 104 will now be described in greater detail. The finish member 104 may be an elongate member formed from a rigid or semirigid material, a few suitable examples being cellular materials, extruded materials, molded materials, foam, etc. In one working embodiment, the finish member 104 is made from extruded foam which is extruded through a die having a preselected perimeter shape 146, such as the perimeter shape 146 shown

The illustrated perimeter shape 146 includes a finish layer 148 of a non-foam material, adapted to provide an aesthetically pleasing appearance to the viewed surface of the architectural detailing assembly 100. The illustrated perimeter shape 146 also includes a top surface 150 extending inward, substantially horizontally, from the finish layer 148. The top surface 150 may be perpendicularly oriented relative to the back surface 110 of the base member 102, or may be inclined at other angles to the back surface 110. For instance, in the illustrated embodiment, the top surface 150 is oriented greater than 90 degrees relative to the back surface 110 such that the top surface 150 is inclined relative to a horizontal plane when installed. This inclining of the top surface 150 relative to a horizontal plane aids in impeding water build up on the top surface 150 by providing a sloped surface for directing rain water off of the top surface 150. In the illustrated embodiment, the top surface 150 is sloped toward the building structure 106, which in the illustrated embodiment, is a parapet. Thus, rain water is directed onto a roof for disposal. For instance, the top surface 150 may be inclined relative to the back surface 110 from greater than about 90 degrees to 135 degrees, and more preferably from greater than about 90 degrees to 105 degrees, even more preferably from greater than about 90 degrees to 100 degrees, and most preferably about 93 degrees

An interface surface 152 may extend diagonally between the back and top surfaces 154 and 150. The interface surface 152 is adapted to interlock with the base member 102. To accomplish the interlocking, the interface surface 152 may include one or more interfacing or interlocking structures adapted to interlock with correspondingly shaped interfacing or interlocking structures disposed on the base member 102. Moreover, as described above, in the illustrated embodiment, the base member 102 includes interlocking structures in the form of alternating recesses, such as grooves 116, and protrusions, such a tongues 118. These interlocking structures 116 and 118 are adapted to interlock with correspondingly shaped interlocking structures associated with the finish member 104, the interlocking structures being recesses, such as grooves 120, and protrusions, such as tongues 122, adapted to interlock with the tongues 118 and grooves 116 of the base member 102, respectively. In the illustrated embodiment, the interlocking structures 116, 118, 120, and 122 are elongate members which are oriented substantially parallel with and extend along substantially the entire length of their respective base or finish member 102 or 104. The interlocking structures 116, 118, 120, and 122, may be oriented to permit the finish member 104 to be slidingly engaged with one another by sliding the finish member 104 towards the base member 102 in a first direction 132. If needed, the finish member 104 may also be slid longitudinally along the length of the base member 102 to align the end face of the finish member 104 to the end face of the base member 102. However, the interlocking structures 116, 118, 120, and 122, interact with one another to impede movement of the finish member 104 perpendicular to the first direction 132, with exception of along the length of the base member 102, as noted above. An adhesive, or other fastening method, such as mechanical fasteners, may be used to secure the finish member 104 to the base member 102.

The finish member 104 is preferably of a reduced depth such that the finish member 104 may be easily cut with standard power tools. For instance, in one embodiment, the finish member 104 is less than about 5 inches in height and/or width, such that standard power tools can cut the finish member 104 in one pass. Preferably, the finish member 104 is less than about 4 inches in height and/or width such that a standard circular saw can cut through the finish member 104 in one pass, resulting in significant cost and labor savings over conventional applications which require custom saws to cut through the entire width and/or height of the cornice piece in one pass

In light of the above description of the components of the architectural detailing assembly 100, the installation of the architectural detailing assembly 100 will now be described. Referring to FIG. 1, the base member 102 and the finish member 104 are extruded and allowed to cure. Turning to FIG. 2, the fastening members 126 and 130 are inserted and secured within their respective preformed recesses 124 and 128 with an adhesive. Referring to FIG. 2, the base member 102 is then attached to the building structure 106 by fastening the tab portion 136 of the attachment fastening member 130 to the building structure 106.

Turning to FIG. 3, the finish member 104 is then attached to the base member 102 by engaging the interlocking structures 120 and 122 on the finish member 104 with the interlocking structures 116 and 118 on the base member 102. Preferably, an adhesive is applied to the interface surface 114 of the base member 102 and/or the finish member 104, and the finish member 104 is slid inward 132 toward the base member 102 to interlock the interlocking structures 114, 116, 120, and 122 to one another. Once the adhesive cures, the architectural detailing assembly 100 is permanently held in place.

Referring to FIG. 1, the top surface 112 of the architectural detailing assembly may be finished in any suitable manner. For instance, a base structure 138, such as plywood, may be fastened to the architectural detailing assembly 100 via fasteners 140 interfacing with the anchor fastening member 126. The base structure 138 may then be covered with a waterproof or water resistance barrier 142, which may, in turn, be covered with flashing 144.

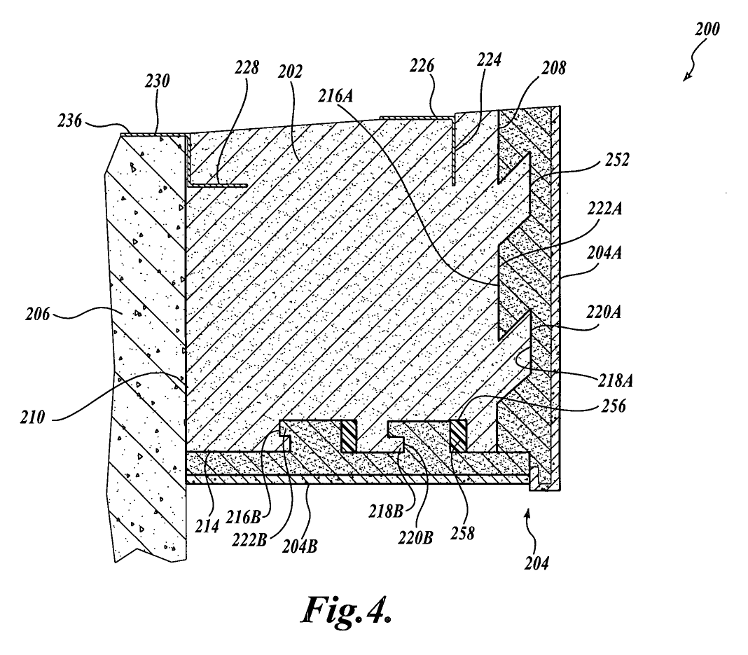

Referring to FIG. 4, an alternate embodiment of an architectural detailing assembly 200 formed in accordance with the present invention is illustrated. The architectural detailing assembly 200 is substantially similar in construction, installation, and use as the above-described embodiment. Therefore, for the sake of brevity, only those aspects of the architectural detailing assembly 200 which depart from the previously described embodiment will be described in detail

The architectural detailing assembly 200 is substantially similar to the previously described embodiment with exception of the perimeter shape 208 of the base member 202, the manner in which the finish member 204 is coupled to the base member 202, and in that the finish member 204 is now formed from two (or more) sections. This detailed description will therefore focus on these aspects of the architectural detailing assembly 200.

Focusing on the change of the perimeter shape 208 of the base member 202, the perimeter shape 208 is now substantially square in cross-section, rather than substantially triangular as shown for the above described embodiment. Further, the interlocking structures 216 and 218 of the base member 202 are now oriented in different directions, with a few of the interlocking structures 216 and 218, such as interlocking structures 216A and 218A, oriented so as to be inclined relative to a vertical plane (or back surface 210 of the base member 202), such as an inclination between greater than about 0 degrees and less than about 90 degrees relative to the vertical plane, and more preferably between greater than about 20 degrees and less than about 70 degrees, and even more preferably between greater than about 30 degrees and less than about 60 degrees, and most preferably at an inclination of about 45 degrees relative to the vertical plane.

Other interlocking structures 216 and 218, such as interlocking structure 216B and 218B, may be oriented at other inclinations relative to the vertical plane (or back surface 210). For instance interlocking structures 216B and 218B are oriented substantially perpendicular to the vertical plane so as to be substantially horizontally oriented. Although a single angular orientation of the interlocking structures 216B and 218B is illustrated and described, it should be apparent that other angular orientations are suitable for use with the present invention, such as angular orientations of between greater than about 45 degrees and less than about 135 degrees

The interlocking structures 216B and 218B are also different in design than previously described interlocking structures. Moreover, interlocking structures 216B and 218B each include a locking cavity 256 adapted to slidingly receiving a locking member 258 adapted to lock the finish member 204 to the base member 202 by blocking the base member 202 from moving back into the locking cavity 256 once the locking member 258 is inserted therein, as will be described in more detail below

Focusing now on the finish member 204, the finish member 204 is formed from an upper section 204A and a bottom section 204B. Thus, the finish member 204 may be manufactured, stored, handled, and installed in separate, smaller sections, greatly reducing the costs and labor associated with each of these activities.

In light of the above description of the components of the architectural detailing assembly 200, the installation of the architectural detailing assembly 200 will now be described. Still referring to FIG. 4, the base member 202 and the finish member 204 are extruded and allowed to cure. The fastening members 226 and 230 are inserted and secured within their respective preformed recesses 224 and 228 with an adhesive. The base member 202 is then attached to the building structure 206 by fastening the tab portion 236 of the attachment fastening member 230 to the building structure 206.

The bottom section 204B of the finish member 204 is then attached to the base member 202 by engaging the interlocking structures 216B and 218B on the bottom section 204B with the interlocking structures 220B and 222B on the base member 202. Preferably, an adhesive is applied to the interface surface 214 of the base member 202 and/or the bottom section 204B of the finish member 204, and the bottom section 204B is slid inward toward the base member 202 to interlock the interlocking structures 216B, 218B, 220B, 222B to one another. The locking member 258 is then slid into the locking cavity 256 to block the bottom section 204B from moving back into the locking cavity 256

The upper section 204A of the finish member 204 is then attached to the base member 202 by engaging the interlocking structures 220A and 222A on the upper section 204A with the interlocking structures 216A and 218A on the base member 202. Preferably, an adhesive is applied to the interface surfaces 214 and 252 of the base member 202 and/or the upper section 204A of the upper section 204A, and the finish member 204 is slid inward toward the base member 202 to interlock the interlocking structures 216A, 218A, 220A, and 222A to one another. Once the adhesive cures, the architectural detailing assembly 100 is permanently held in place.

Although the finish member is illustrated and described in the above embodiments as being formed from either one or two sections, it should be noted that this is for illustrative purposes only, and the finish member may also be formed from three or more sections. Although the base member is illustrated and described in the above embodiments as being formed from one section, it should be noted that this is for illustrative purposes only, and the base member may also be formed from two or more sections.

Although a preselected perimeter shape is illustrated and described for the base and finish members, it should be noted that alternate perimeter shapes are within the spirit and scope of the present invention.

While the preferred embodiment of the invention has been illustrated and described, it will be appreciated that various changes can be made therein without departing from the spirit and scope of the invention

The embodiments of the invention in which an exclusive property or privilege is: claimed are defined as follows:

1. An architectural detailing assembly adapted to be attached to a building structure, the architectural detailing assembly comprising:
(a) a base member adapted to be attached to the building structure, the base member including a first interface structure; and
(b) a finish member adapted to be attached to the base member, the finish member including a second interface structure adapted to cooperatively interface with the first interface structure to aid in supporting the finish member upon the base member.

2. The architectural detailing assembly of claim 1, wherein the base member and the finish member are formed from extruded material.

3. The architectural detailing assembly of claim 1, wherein the base member and the finish member are at least partially formed from foam.

4. The architectural detailing assembly of claim 3, wherein the base member includes a fastening member formed from a non-foam material, the fastening member adapted for receiving fasteners used in coupling a building material or a building structure to the architectural detailing assembly.

5. The architectural detailing assembly of claim 1, wherein the base member includes a preformed recess adapted to receive a fastening member therein.

6. The architectural detailing assembly of claim 5, wherein the preformed recess includes an elongate slot passing along substantially an entire length of the base member, the elongate slot shaped and sized to cooperatively received at least a portion of the fastening member.

7. The architectural detailing assembly of claim 1, wherein the finish member includes a foam core and a non-foam finish material applied to at least a portion of the foam core.

8. The architectural detailing assembly of claim 1, wherein a thickness of the base member does not exceed about five inches and wherein a thickness of the finish member does not exceed about five inches.

9. The architectural detailing assembly of claim 1, wherein the first and second interface structures are adapted to slidingly engage one another in a first direction when the base member is interfaced with the finish member.

10. The architectural detailing assembly of claim 9, wherein the first and second interface structures interfere with one another to impede movement between the first and second interface structures perpendicular to a length of the base member when the finish member is coupled to the base member.

11. The architectural detailing assembly of claim 1, wherein the building structure is a parapet wall, and wherein the architectural detailing assembly includes a back surface adapted to be coupled to the parapet wall and a top surface inclined greater than 90 degrees from the back surface.

12. The architectural detailing assembly of claim 1, wherein the base member includes a locking cavity adapted to sliding receiving a locking member adapted to lock the finish member to the base member by blocking the base member from moving into the locking cavity.

13. An architectural detailing assembly adapted to be attached to a building structure, the architectural detailing assembly comprising:
(a) a base member formed from extruded cellular material and adapted to be attached to the building structure, the base member having a first interlocking structure;
(b) a finish member formed from extruded cellular material and having a second interlocking structure adapted to cooperatively interlock with the first interlocking structure disposed on the base member for interlocking the finish member to the base member;
(c) an anchor fastening member at least partially embedded in the base member, the anchor fastening member adapted to provide a rigid structure for a fastener to attach thereto; and
(d) an attachment fastening member at least partially embedded in the base member, the attachment fastening member adapted to provide a rigid structure for coupling the base member to the building structure.

14. The architectural detailing assembly of claim 13, wherein the base member includes a preformed anchor fastener recess sized and shaped to at least partially receive the anchor fastener member, wherein the anchor fastening recess extends along substantially the entire length of the base member.

15. The architectural detailing assembly of claim 14, wherein the base member includes a preformed attachment fastener recess sized and shaped to at least partially receive the attachment fastening member, wherein the preformed attachment fastener recess extends along substantially the entire length of the base member.

16. An architectural detailing assembly adapted to be attached to a building structure, the architectural detailing assembly comprising:
(a) a base member formed from extruded cellular material and adapted to be attached to the building structure;
(b) a finish member formed from extruded cellular material and having interlocking structures for interlocking with cooperatively shaped interlocking structures disposed on the base member for interlocking the finish member to the base member;
(c) an extruded finish material covering at least a portion of the finish member.

17. The architectural detailing assembly of claim 16, wherein the interlocking structures of the finish member are adapted to slidingly interface with the cooperatively shaped interlocking structures in a first direction when the finish member is interlocked with the base member.

18. The architectural detailing assembly of claim 17, wherein the interlocking structures of the finish member include an elongate groove or an elongate tongue and wherein the cooperatively shaped interlocking structures of the base member include the other of the elongate groove or the elongate tongue.

19. The architectural detailing assembly of claim 18, wherein the elongate groove and elongate tongue are oriented substantially perpendicular to the first direction.

20. The architectural detailing assembly of claim 16, wherein the base member includes a preformed recess extend along substantially the entire length of the base member for at least partially receiving a fastening member therein.
